(19) United States
(12) Patent Application Publication
(10) Pub. No.: US 2003/0167249 A1
(43) Pub. Date: Sep. 4, 2003

(54) Process for defining a method based on expert know-how

(76) Inventor: Hisup Park, Concord, CA (US)

Correspondence Address: THEODORE J. BIELEN, JR., Bielen, Lampe & Thoeming, Suite 720, 1990 N. California Blvd., Walnut Creek, CA, 94596, US

(21) Appl. No.: 09/740,198

(22) Filed: Dec. 18, 2000

(51) Int. Cl. G06F 7/00

(52) U.S. Cl. 707/1

(57) ABSTRACT

A process for defining a method to be followed by a user for achieving a result based on the know-how of an expert utilizing the step of providing a computer generated visual representation of a task. The task requires an activity of the user and results in another computer generated visual representation for such result, identified as an item. Another computer generated visual representation represents an agent which at least partially aids the user in carrying out the task. Links are provided between the task, the result, and the agent and are also computer generated. The resultant layout provides a user a map representing a method to be followed to achieve a particular goal.

### BACKGROUND OF THE INVENTION

The present invention relates to a novel and useful process for defining or mapping a method for a user to reach a goal, based on expert know-how.

Multi-step processes must be followed on a daily basis to accomplish a particular end or goal. In the past, successfully proceeding toward a goal required a high degree of education and training, or following a tortured path through a trial and error procedure. Acquiring of such knowledge usually required traditional education tools such as learning institutions, libraries, tutors, and the like. In the recent past, a plethora of information has been disseminated on the global computer network which is easily obtained through a personal computer or the like by a user.

Unfortunately, a majority of the information found on the global computer network is created by persons, typically programmers, lacking expertise who, have provided misinformation in a particular field of endeavor, due to lack of expertise.

Experts have also put forth information on the global computer network. However highly trained and educated experts in particular fields generally propound theories and methods which are complex and difficult to understand by the average person.

Formal documentation of processes have been used in rather complex situations to describe the ebb and flow of a project. For example, PERT charts, work-flow diagrams, and the like serve as formal, and thorough methods to achieve and end result. However, such documentation lacks facility in the hands of the normal user.

A process for defining a method to allow a user to achieve a goal based on the know-how of an expert would be a notable advance in the educational field.

### BRIEF SUMMARY OF THE INVENTION

In accordance with the present invention a novel and useful process for defining a method to be followed by a user to achieve a goal based on the guidance of an expert is herein provided.

The process of the present invention utilizes a computer program which permits an expert to build or create a pathway to be followed by a user generally based on tasks, items, and agents. The tasks may require certain input and produce a result or output i.e. an item. In any case, the process of the present invention provides a computer generated visual representation of a task which is based on the know-how of an expert. That is to say, the task represents a required activity of the user. In certain cases, the process of the present invention also provides a computer generated visual representation of an agent for at least partially carrying out the task. Likewise, a computer generated visual representation is also included for showing a result which is a consequence of carrying out the task. Links, which are computer generated also tie together the tasks, items, as well as the agent when such agent is assigned a task, as the case may be. In certain cases, the agent may also be a recipient of the result flowing from the task which has been accomplished by the user.

The process of the present invention employs an expert directly. In certain cases, the expert may determine that a certain task may include alternate results depending on choices provided to the user when the task is performed.

Defining a task also may include embedding a sub-process within that task that is to say a general task may be employed and designated by the expert which requires multiple steps through a sub-process. In any case, the output of the sub-process also serves as the output to the item or result linked to the general task.

The computer generated visual representations of tasks, results, links, and the like may be presented as a matrix or as a graph. In any case, the user would have the choice of the type of visual representation desired through the process of the present invention. Other links may be noted in the process of the present invention. For example, feedback links may loop back from a result to a prior task. In many cases such input relationship indicates that the task is effected by such feedback, but that the task may proceed without the same. In addition, weak output relationships may be noted between tasks and results accomplished before the call for task. Finally, agents inputting or receiving output from this process of the present invention may be linked with a computer generated visual image.

It may be apparent that a novel and useful process for defining a method for guiding a user to a goal based on expert know-how is hereinabove described. It is therefore an object of the present invention to provide a process for defining a method for guiding a user to a goal based on the know-how of an expert which permits such expert to construct or build a pathway toward a particular goal-using computer generated visual images.

Another object of the present invention is to provide a process for guiding the user to a goal based on the know-how of an expert which considers multiple alternatives and feedbacks from tasks and results found in the system constructed by the expert.

A further object of the present invention is to provide a process for defining a method for guiding a user to a goal based on the know-how of an expert which employs the use of outside agents who at least aid in the carrying out of a particular task or who serve as the recipient of data resulting from the task.

A further object of the present invention is to provide a process for defining a method for guiding a user to a goal based on the know-how of an expert which defines tasks in a general format, as well as adjunct tasks which may be embedded in the general task.

A further object of the present invention is to provide a process for defining a method for guiding a user to a goal based on the know-how of an expert which utilizes the publications, experience, and inherent knowledge of an expert as a basis.

Another object of the present invention is to provide a process for defining a method for guiding an individual or user to a goal based on the know-how of an expert which employs visual representations that may be formatted in a matrix, graph, or a list.

The invention possesses other objects and advantages especially as concerns particular characteristics and features thereof which will become apparent as the specification continues.

### BRIEF DESCRIPTION OF THE SEVERAL VIEWS OF THE DRAWING

FIG. 1 is a schematic view showing the overall interaction between an expert, the creation of a process model, and a uploading of the process model to the global computer network.

FIG. 2 is a flow diagram depicting the details of constructing the process model utilized by an expert.

FIG. 3 is a flow diagram illustrating a typical combination of tasks and items created by an expert as a process to be followed by a user.

FIG. 4 is a flow diagram showing an example of an application of a process created by an expert to be followed by a user.

FIG. 5 is a flow diagram illustrating a sub-process embedded in a portion of a task depicted in FIG. 4.

For a better understanding of the invention reference is made to the following detailed description of the preferred embodiments thereof which should be taken in conjunction with the prior described drawings.

### DETAILED DESCRIPTION OF THE PREFERRED EMBODIMENTS OF THE INVENTION

Various aspects of the present invention will evolve from the following detailed description of the preferred embodiments thereof which should be taken in conjunction with the prior delineated drawings.

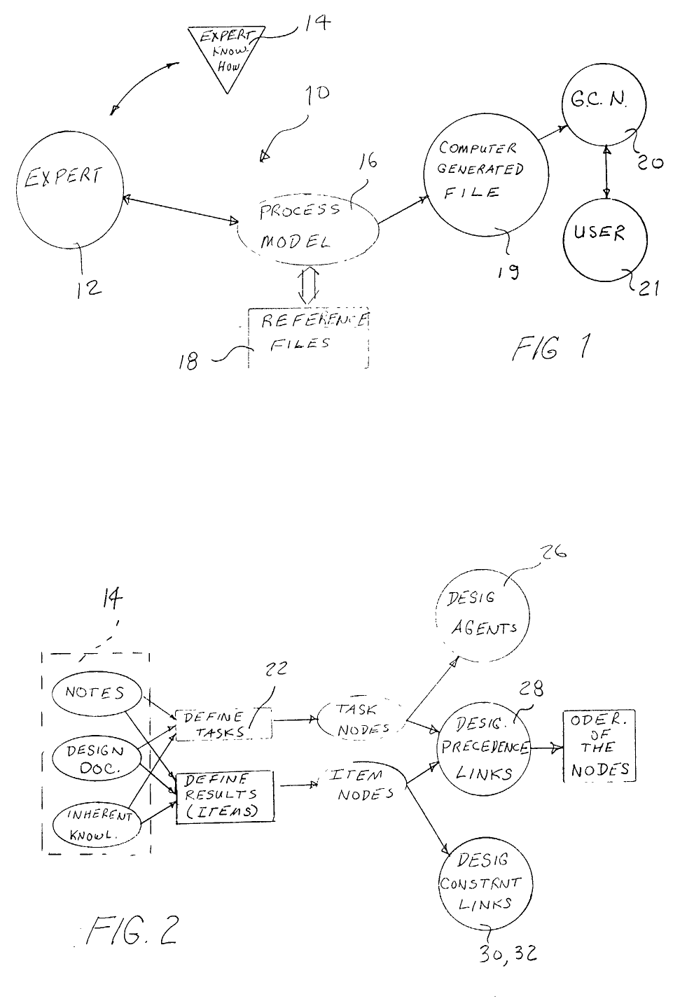

The process 10 of the present invention is generally depicted in an overview in FIG. 1. An expert 12 possessing expert know-how 14 creates a process model 16 which may be visualized by a user. Process model 16 also uses reference files 18 defined by the expert. The process model may be provided as a computer generated file 19 that is uploaded to the global computer network 20 for employment by a user 21. In this regard, the machine code of a computer program employed by an expert to create the process model 16 and computer generated file, depicted in FIG. 1, is attached hereto in compact disc form, identified as “iBuilder”, created Jan. 20, 2000, and 210 Kb in size.

In essence, process 10 is a tool which allows an expert 12 to create interactive guidance sessions which are eventually employed by a user on the global computer network through a personal computer. It should be noted that process 10 permits expert 12 to employ his know-how, which includes experience of the expert 12, documents created by the expert 12, and the inherent knowledge of an expert 12. The process model 16 resulting from the input of expert 12 input into process 10 may be refined or changed as time goes on. The essence of process 10 is the separation of an expert's 12 know-how into well-defined steps which may be easily followed by a user 21.

With reference to FIG. 2 it may be observed that an expert's know-how 14 is depicted as consisting as inherent knowledge, designed documents, notes, and the like. The first element of process model 16 is to define a task 22. A task 22 is a unit of activity that generally requires an input or inputs and generates an output. The results or outputs from a task are defined as an item 24. As indicated in FIG. 2, after the expert defines tasks 22, he must also define results or items 24. It should be noted that items 24 may serve as an input or output relative to a task when a pathway is defined utilizing multiple tasks. In other words, items represent entities that are necessary to execute a process. In certain cases, items may be found as variables whose values are determined as a result of performing a task that precedes it. In addition to the task/item relationship defined by the expert 12, agents 26 may be assigned to at least partially, and in some cases wholly, perform a task on behalf of the user. Once the sequence of the tasks 22, items 24, and agents 26 are linked together in a sequence, the tasks 22, items 24, and agents 26 are visual noted as node objects or nodes having characteristics geometric outlines. These entities are the linked, which will be described in greater detail hereinafter. The computer program hereinabove, referenced as Appendix 1, will then “order” the nodes to create a visual representation of the method to be followed by a user 21 in achieving a goal.

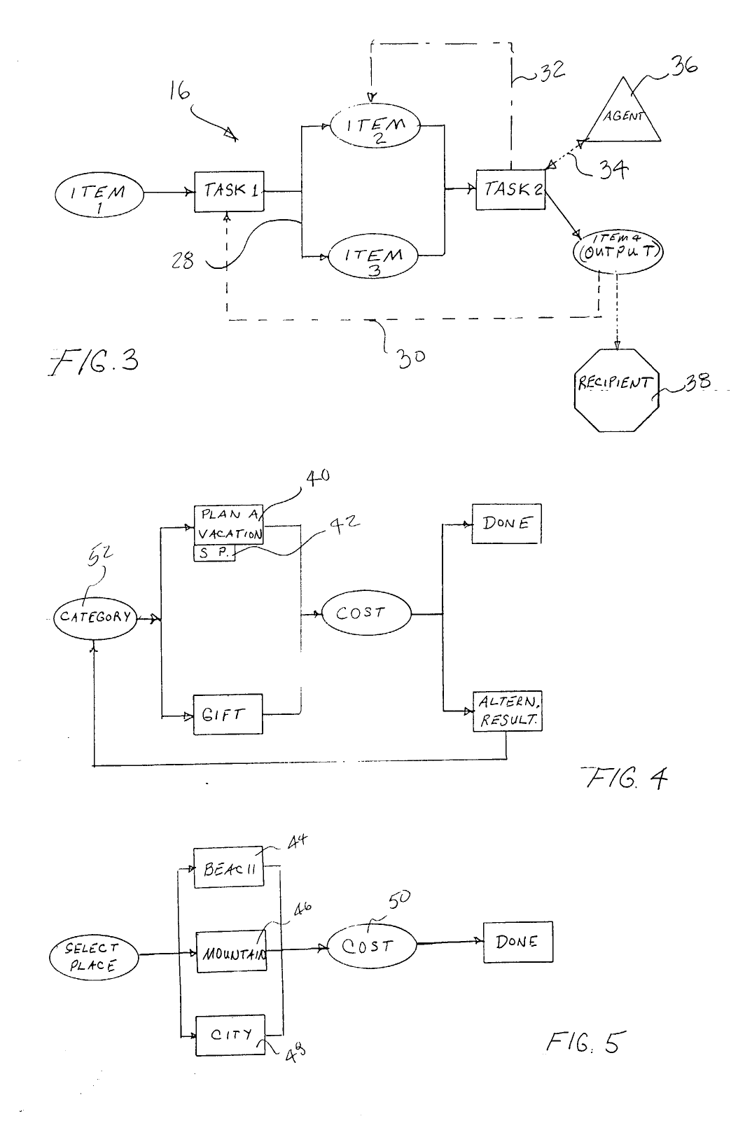

Referring now to FIG. 3, it may be observed that tasks 22, items 24, and agents 26 of FIG. 2 have been designated for a particular process model 16. In general, visual representation of tasks, items, and agents are represented by rectangles, ovals, and triangles, respectively. It should be realized that such assignment of visual symbols is arbitrary and may be altered in any manner. Most importantly, different visual symbols are employed for the purpose of distinctiveness between tasks 22, items 24, and agents 26. In addition to such visual representations, tasks 22, items 24, and agents 26 are linked. For example, links between tasks and items such as link 28, are referred to as precedence links 28. Precedence links 28 are noted in process model 16 by solid lines. By definition, a precedence link 28 indicates that a task can proceed only when all required inputs are available. Similarly, an item 24 is not available until all incidence tasks 22 that precede a particular item 24 have been finished. Other links are found in addition to a precedence link 28 in that a task 22 or item 24 is merely affected. In other words, process model 16 may proceed through precedence links 28 despite such effect. For example, in FIG. 3, a feedback link 30 is indicated in dash line between item 4 and task 1. Again, feedback link 30 is a weak input relationship between task 1 and item 4 and may indicate that “task 1” may need to be repeated. Side-effect link 32 is also indicated on FIG. 3. Side effect link 32, noted by alternating long and short dashes, again indicates a week output relationship.

Another type of link is an assignment link, dotted line, such as assignment link 34 shown between task 2 and agent triangle 36, FIG. 3. Item 4, which is the output of task 2, also is depicted as sending such output to a recipient 38 noted by a octagonal enclosure. In a sense, recipient 38 may be considered an output agent while agent 36 may be considered an input agent to process model 16.

Agent 36 is indicated in FIG. 3 as being assigned to execute task 2. When such is completed task 2 is ended, item 4 output will result. Agent 36 is considered to be an internal agent as it performs task 2 internal to process model 16. Other agents may be noted in process model 16, such as external agents, that perform a task outside process model 16. External agents, however, exchange information with process model 16 for the purpose of data transfer or coordination. External agents may take the roll of a supplier or as a role of a recipient of an output such as recipient 38. External agents may interrupt the flow of process model 16 until the required input from an external agent is provided to process model 16. At that point, further tasks and items may occur if the user proceeds through process model 16.

Once the expert 12 lays out a basic process the computer program, hereinabove noted, will permit the expert to build a process model 16. Again, the expert may employ inherent knowledge, flow diagrams, project charts previously created, and the like to construct process model 16.

Referring now to FIG. 4, it may be observed that a particular application of process 10 is denoted. For example, visual representations of items 24, tasks 22, and outputs are shown with respect to the alternative steps of planning a vacation or purchasing a gift. Rectangle 40 indicating that the user 21 is planning a vacation also includes a sub-process box 42. FIG. 5 denotes such sub-process which has been embedded or attached to the general process of planning of vacation. For example, three tasks indicating types of vacations 44, 46, and 48 are explored prior to entering cost item 50.

Although the visual representations illustrated in the drawings show graphical use, the expert creating process model 16, through the computer program above noted as Appendix 1, may select other visual representations of the process model 16. For example, a matrix view may be called up representing the relationship between nodes or node objects. In addition, a filter node may be employed to rearrange the relationships within the matrix. In addition, list views may be employed. That is to say, tasks may be listed alphabetically with detailed labels. Further, items may be listed alphabetically in the same manner. Through these features, the expert 12 is able to accurately build and refine process model 16 for eventual use by the user. In addition, the computer program, above identified, automatically orders the nodes i.e. sequencing items 22, tasks 24 and agents 26 and 36 based on the relationships established by precedence links. The technical term for such process is called the “topological ordering of the nodes”.

Where a variable exists in the process model 16, such as the variables indicated in FIG. 4 following category box 52, such variable may be designated according to particular characterizations, for example Boolean, real-type, string, integer, values, and the like.

Following creation of process model 16 by an expert, the process model 16 is provided in a computer generated filed that may be uploaded to the global computer network (GCN) 20, FIG. 1 by the guidelines provided in the computer program above-identified as Appendix 1. A user 21 having a personal computer may then follow process model 16, step-by-step, in particular categories of expertise without deciphering matrices, lists, flow-charts, and the like used by expert 12 as a basis for process model 16. For example, process models may concern the fields of real estate, health care, medical referrals, personal money management, software manuals, training in various fields, travel procedures, and the like.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. A process for defining a method to be followed by a user for achieving a goal based on the know-how of an expert, comprising:
a. providing a computer generated visual representation of a task based on the know-how of the expert, said task representing a required activity of the user;
b. providing a computer generated visual representation of an agent for at least partially carrying out said task;
c. providing a computer generated representation of a result from carrying out said task;
d. providing a first computer generated visual representation of a first link between said task and said result from carrying out said task; and
e. providing a second computer generated visual representation of second link between said task and said agent for at least partially carrying out said task.

2. The process of claim 1 in which at least one of said computer generated visual representation is a graphical representation.

3. The process of claim 1 in which at least one of said computer generated visual representation is a matrix representation.

4. The process of claim 1 which said additionally comprises the step of providing a computer generated visual feedback effect link between said computer generated visual representation of a task and said computer generated visual representation of a result.

5. The process of claim 1 which additionally comprises the step of providing a computer generated visual link between result and a recipient of said result.

6. A process for defining a method of achieving a goal using the know-how of an expert, comprising:
a. providing a computer generated visual representation of a first task based on the know-how of the expert, said first task representing a required activity;
b. providing a computer generated visual representation of at least first and second alternate results from carrying out said first task;
c. providing a computer generated visual representation of a link between said first task and said first and second alternate results from carrying out said first task;
d. providing a computer generated visual representation of an information link selectively to said first and second alternate results;
e. providing a computer generated visual representation of a second task based on the know-how of the expert, said second task representing a required activity; and
f. providing a computer generated link to said second task from said first and second alternate result.

7. The process of claim 6 which additionally comprises the step of providing a computer generated visual representation of an output based on said second task and a computer generated visual link between said second task and said output.

8. The process of claim 7 in which at least one of said computer generated visual representation is a graphical representation.

9. The process of claim 7 in which at least one of said computer generated visual representation is a matrix representation.

10. The process of claim 7 which said additionally comprises the step of providing a computer generated visual feedback effect link between said computer generated visual representation of a task and said computer generated visual representation of a result.

11. The process of claim 7 which additionally comprises the step of providing a computer generated visual link between result and a recipient of said result.

12. The process of claim 7 which additionally comprises the step of providing a computer generated visual representation of an agent for a at least partially carrying out said task and a computer generated visual representation of a link between said task and said agent for at least partially carrying out said task.

13. A process for defining a method to be followed by a user for achieving a goal based on the know-how of an expert, comprising:
a. providing a computer generated visual representation of a task based on the know-how of the expert representing a required activity of the user;
b. providing a computer generated visual representation of a process embedded in said task;
c. providing a computer generated visual representation of a result from carrying out said task; and
d. providing a computer generated visual representation of a link between said task and said result from carrying out said task.

14. The process of claim 13 which additionally comprises the step of providing a computer generated visual representation of an agent for a at least partially carrying out said task and a computer generated visual representation of a link between said task and said agent for at least partially carrying out said task.

15. The process of claim 13 in which at least one of said computer generated visual representation is a graphical representation.

16. The process of claim 13 in which at least one of said computer generated visual representation is a matrix representation.

17. The process of claim 13 which said additionally comprises the step of providing a computer generated visual feedback effect link between said computer generated visual representation of a task and said computer generated visual representation of a result.

18. The process of claim 13 which additionally comprises the step of providing a computer generated visual link between result and a recipient of said result.

19. The process of claim 1 which additionally comprises the further step of providing a computer generated file which embodies steps a-e, and uploading said computer generated file to the global computer network for employment by the user.
